(19) United States
(12) Patent Application Publication
(10) Pub. No.: US 2023/0203754 A1
(43) Pub. Date: Jun. 29, 2023

(54) METHOD AND APPARATUS FOR EVALUATING A HEALTH STATUS OF A DOCTOR BLADE OF A PAPERMAKING MACHINE, AND COMPUTING DEVICE

(71) Applicant: AKTIEBOLAGET SKF, Goteborg (SE)

(72) Inventors: Kaihuan ZHANG, Hangzhou (CN); Biao WU, Suzhou (CN); Gang CHENG, Shanghai (CN)

(21) Appl. No.: 17/986,251

(22) Filed: Nov. 14, 2022

(30) Foreign Application Priority Data
Dec. 23, 2021 (CN) 202111590541.0

(51) Int. Cl. D21G 9/00; D21G 3/00

(52) U.S. Cl. CPC D21G 9/0054; D21G 3/005

(57) ABSTRACT

A method for evaluating a health status of a doctor blade of a papermaking machine includes obtaining doctor blade-related data, wherein the doctor blade-related data includes working condition data, status monitoring data, and design parameter data of the doctor blade, performing data pre-processing on the doctor blade-related data in a predetermined pre-processing manner to obtain a pre-processed data set, wherein the pre-processed data set includes processed data respectively corresponding to the working condition data, the status monitoring data, and the design parameter data. performing feature extraction on the pre-processed data set in a predetermined feature extraction manner, and processing extracted features to obtain processed feature data, and evaluating with respect to working condition, status monitoring, and design parameter respectively based on the processed feature data, to perform a comprehensive evaluation on the health status of the doctor blade of the papermaking machine.

### CROSS-REFERENCE

This application claims priority to Chinese patent application no. 202111590541.0 filed on Dec. 23, 2021, the contents of which are fully incorporated herein by reference.

### TECHNOLOGICAL FIELD

The present disclosure relates to the field of manufacturing, and more particularly, to a method and an apparatus for evaluating a health status of a doctor blade of a papermaking machine, and a computing device

### BACKGROUND

Various types of doctor blades are widely used in papermaking machines, such as creping doctor blades, cleaning doctor blades, etc. A doctor blade is one of the components in papermaking machines that often need to be checked and replaced due to serious wear.

At present, due to insufficient evaluation and optimization, doctor blades of papermaking machines are generally replaced based on the operator's experience, which may lead to inappropriate occasions of doctor blade replacement, and there are also different evaluation criteria depending on different operators. Thus, if the replacement is too early, the doctor blade and replacement time will be wasted additionally; and if the replacement is too late, the unhealthy doctor blade may cause chatter, degradation of paper quality and even damage to the Yankee cylinder.

In addition, health status evaluation on doctor blades of papermaking machines have traditionally been handled through periodic inspection and planned maintenance, and have been handled manually in most cases. This manual manner is usually fixed, inflexible, on-site and experience-based, which leads to excessive or insufficient doctor blade maintenance.

Therefore, there is a need for a solution to automatically and comprehensively evaluate the health status of the doctor blades of the papermaking machines, so that the doctor blades can be replaced at an appropriate occasion.

### SUMMARY

In accordance with an aspect of the present disclosure, there is provided a method for evaluating a health status of a doctor blade of a papermaking machine, comprising: obtaining doctor blade-related data, wherein the doctor blade-related data includes working condition data, status monitoring data, and design parameter data of the doctor blade; performing data pre-processing on the doctor blade-related data in a predetermined pre-processing manner to obtain a pre-processed data set, wherein the pre-processed data set includes processed data respectively corresponding to the working condition data, the status monitoring data, and the design parameter data; performing feature extraction on the pre-processed data set based in a predetermined feature extraction manner, and processing extracted features to obtain processed feature data; and evaluating with respect to working condition, status monitoring, and design parameter based on the processed feature data respectively, to perform a comprehensive evaluation on the health status of the doctor blade of the papermaking machine.

In accordance with another aspect of the present disclosure, there is provided an apparatus for evaluating a health status of a doctor blade of a papermaking machine, comprising: an obtaining module configured to obtain doctor blade-related data, wherein the doctor blade-related data includes working condition data, status monitoring data, and design parameter data of the doctor blade; a pre-processing module configured to perform data pre-processing on the doctor blade-related data in a predetermined pre-processing manner to obtain a pre-processed data set, wherein the pre-processed data set includes processed data respectively corresponding to the working condition data, the status monitoring data, and the design parameter data; a feature extraction module configured to perform feature extraction on the pre-processed data set based in a predetermined feature extraction manner, and to process extracted features to obtain processed feature data; and an evaluation module configured to evaluate with respect to working condition, status monitoring, and design parameter based on the processed feature data respectively, to perform a comprehensive evaluation on the health status of the doctor blade of the papermaking machine.

In accordance with yet another aspect of the present disclosure, there is provided a computing device, comprising: a processor; a memory having stored thereon a computer program which, when executed, causes the processor to implement respective steps of the method for evaluating a health status of a doctor blade as described above.

In accordance with yet another aspect of the present disclosure, there is provided a non-transient computer readable storage medium having stored thereon a computer program which, when executed by a processor, causes the processor to implement respective steps of the method for evaluating a health status of a doctor blade as described above.

In accordance with yet another aspect of the present disclosure, there is provided a computer program product comprising a computer program which, when executed by a processor, causes the processor to implement respective steps of the method for evaluating a health status of a doctor blade as described above.

Through the method for evaluating the health status of the doctor blade according to the embodiments of the present disclosure, multi-signal, multi-working condition and multi-dimensional fusion for the original signal data can be realized, and the health status of the doctor blade can be comprehensively analyzed by combining various types of data (e.g., the working condition data, the status monitoring data, and the design parameter data), the obtained health status evaluation result of the doctor blade can more comprehensively reflect the real health status of the doctor blade and evaluate the real performance status and the change law of the doctor blade, thereby more accurate and timely warning, alarm, feedback and optimization strategies can be provided. In the field of papermaking machine where the doctor blade is applied, because the above-mentioned process may be executed at the computing device, online evaluation and monitoring can be realized, the paper-making problems caused by the doctor blade will be timely solved, finally the cost of the paper-making process is reduced, and the quality and efficiency are improved.

### BRIEF DESCRIPTION OF THE DRAWINGS

FIGS. 1A to 1E are schematic diagrams of feature values of feature parameters of a doctor blade changing over time.

FIG. 2 is a flowchart of a method for evaluating a health status of a doctor blade of a papermaking machine according to the embodiments of the present disclosure.

FIGS. 3 to 4 are health radar charts constructed based on the performance-related indicators of features.

FIG. 5 is a schematic diagram of the trend over time of the health status of the doctor blade obtained at different evaluation occasions based on the evaluating method according to the embodiments of the present disclosure.

FIG. 6 is a schematic diagram illustrating a process for evaluating the health status of a doctor blade of a papermaking machine according to the embodiments of the present disclosure.

FIG. 7 is a schematic diagram of an apparatus for evaluating a health status of a doctor blade of a papermaking machine according to the embodiments of the present disclosure.

FIG. 8 is a structural block diagram of a computing device according to the embodiments of the present disclosure.

### DETAILED DESCRIPTION

It should be understood that the following description that provides the embodiments is for the purpose of illustration only and not limitation. The exemplary division among functional blocks, modules or units shown in the figures should not be construed as implying that these functional blocks, modules or units must be implemented as physically separated units. The functional blocks, modules or units shown or described may be implemented as independent units, circuits, chips, functions, modules or circuit elements. One or more functional blocks or units may also be implemented in a common circuit, chip, circuit element or unit.

Although the present disclosure makes various references to certain modules in the system according to the embodiments of the present disclosure, any number of different modules may be used and run on user terminals and/or servers. The modules are illustrative only, and different aspects of the system and method may use different modules.

Flowcharts are used in the present disclosure to illustrate operations performed by a system according to one or more embodiments of the present disclosure. It should be understood that the preceding or following operations are not necessarily performed exactly in sequence. Instead, the various steps may be processed in a reverse order or concurrently, as desired. Meanwhile, other actions may also be added to these processes, or one or several steps may be removed from these processes.

The technical solutions in the embodiments of the present disclosure will be clearly and completely described below with reference to the accompanying drawings in the embodiments of the present disclosure. Obviously, the described embodiments are only some, but not all, embodiments of the present disclosure. Based on the embodiments in the present disclosure, all other embodiments obtained by those of ordinary skill in the art without paying creative efforts fall within the protection scope of the present disclosure.

For health status evaluation on the doctor blade, currently there are some evaluation methods based on status monitoring, but these methods only monitor the overall running trend of the doctor blade, only extract a single type of signals of the doctor blade, for example, a single vibration signal may be acquired to determine whether the current health status of the doctor blade is bad and the doctor blade thus should be replaced. For example, if the chatter of the doctor blade is large, then the amplitude of the corresponding detected vibration signal will be large. Thus, in the case where the threshold value is exceeded, it indicates that the current doctor blade needs to be replaced. Or, the health status of the doctor blade can be determined by tracking the change trend of the signal. In addition, sometimes monitoring may be performed by acquiring the temperature signal.

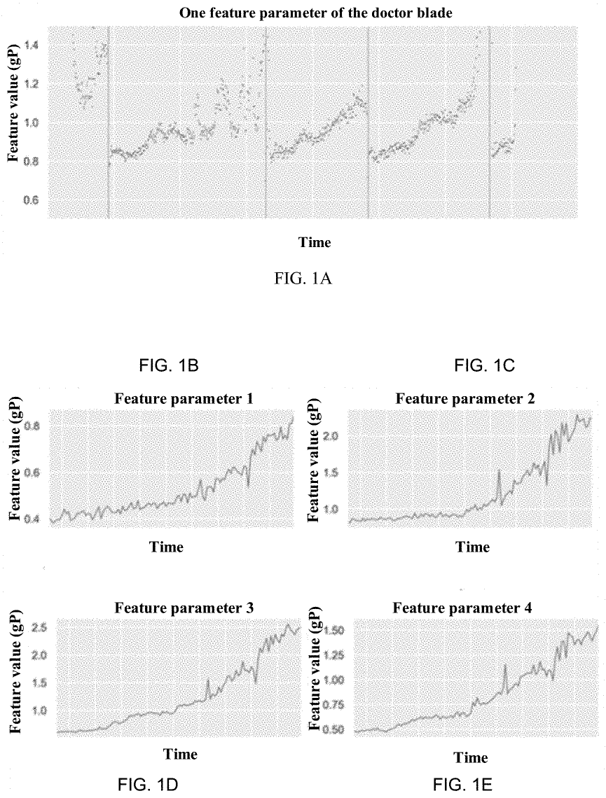

For example, FIG. 1A shows a schematic diagram of the feature value (changing over time) of one feature parameter of a doctor blade at each evaluation occasion under a same working condition during the test.

As shown in FIG. 1A, the abscissa is the time, the ordinate is the feature value of the feature parameter (e.g., the vibration signal of the doctor blade). With the passage of time, the feature value gradually increases, until a certain threshold corresponding to the worst status of the doctor blade is reached, then a new doctor blade needs to be adopted for replacement. For example, a new doctor blade is adopted for replacement at the time corresponding to the vertical line drawn in the figure, so the feature value gradually increases from the small value corresponding to the best status, until the threshold corresponding to the worst status is reached (at the time corresponding to the drawn next vertical line), so the doctor blade is replaced again, and so forth. The time period between the two vertical lines in the figure is regarded as the useful life period of the doctor blade.

FIGS. 1B-1E show schematic diagrams of feature values (changing over time) of four feature parameters of the same doctor blade during the useful life period of the doctor blade under the same working condition during the test.

As shown in FIGS. 1B-1E, the change trend of the feature value of each feature parameter is similar, that is, the feature value gradually increases over time.

However, for this method, it is not comprehensive to evaluate the health status of the doctor blade only through a small number of simple signals, and influences of the working condition and other features of the doctor blade are not taken into consideration either.

Therefore, the present disclosure provides a comprehensive solution for evaluating a health status of the doctor blade. In the evaluation method proposed in the present disclosure, comprehensive analysis is performed by combining various types of data (e.g., the working condition data, the status monitoring data and the design parameter data), and the obtained health status evaluation result of the doctor blade can better reflect the real health status of the doctor blade, and have a higher accuracy.

The evaluating method proposed by the present disclosure will be described in detail below with reference to the accompanying drawings.

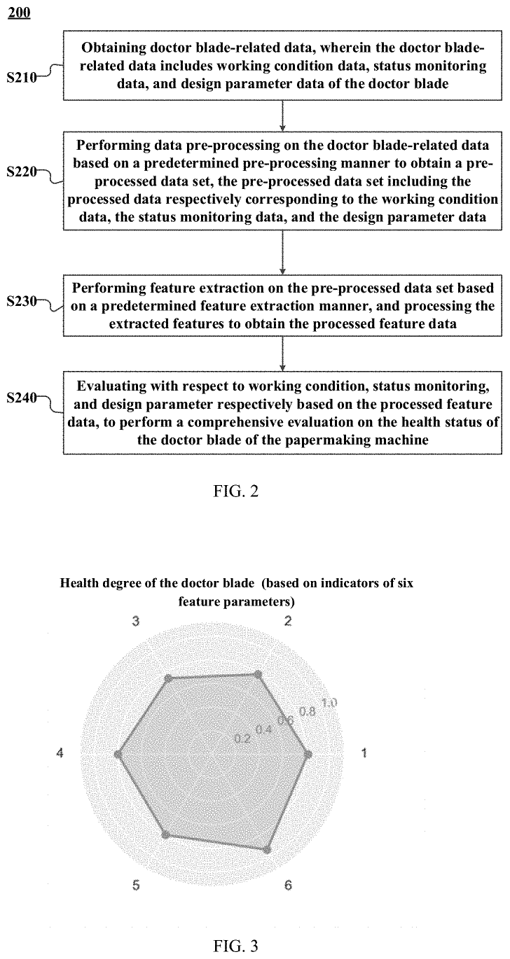

FIG. 2 shows a schematic flowchart of a method for evaluating a health status of a doctor blade according to the embodiments of the present disclosure.

The method may be performed by a computing device with a processing function, and the computing device may include a server or a terminal. The terminal may include but not limited to: a smart phone, a tablet computer, a notebook computer, a desktop computer, a smart TV, etc. Various clients (e.g., application, APP) may run in the terminal, such as a multimedia playback client, a social client, a browser client, a feed client, an education client, etc. The server may be an independent physical server, may also be a server cluster composed of multiple physical servers or a distributed system, may also be a cloud server that provides basic cloud computing services such as cloud service, a cloud database, cloud computing, a cloud function, cloud storage, network service, cloud communication, middleware service, domain name service, security service, CDN, as well as big data and artificial intelligence platform.

As shown in FIG. 2, in step S210, doctor blade-related data is obtained, wherein the doctor blade-related data includes working condition data, status monitoring data, and design parameter data of the doctor blade.

It should be understood that the data here (the working condition data, the status monitoring data and the design parameter data) may be, for example, analog data; or may also be digital data, such as the data related to the value of a voltage signal or current signal. The embodiments of the present disclosure are not limited by the data type of the data.

The working condition data may include data reflecting the real-time processing status of the doctor blade, for example, may include but not limited to time stamp data, Yankee cylinder rotational speed data, process type data, Yankee cylinder surface data, coating material type data, pulp raw material type data, processing ambient temperature data, processing ambient humidity data, etc. One or more types of data to be acquired may be selected based on factory and business requirements. The embodiments of the present disclosure are not limited by the specific composition and type of target working condition data. In the present disclosure, since evaluation on the health status of the doctor blade is required, the selected working condition data is the type of data that is sensitive to the health status of the doctor blade or the type of data that affects the health status of the doctor blade.

The status monitoring data of the doctor blade may include data obtained by monitoring the real-time status of the doctor blade, which can directly or indirectly reflect the real-time status of the doctor blade. The status monitoring data may include but not limited to doctor blade vibration data (e.g., acceleration data of real-time vibration of bearings at a driving end and a non-driving end of a fixing bracket for the doctor blade), contact force data, acoustic transmission data, ultrasonic data, image data, resistance data, temperature data, etc. The embodiments of the present disclosure are not limited by the specific type and composition of the status monitoring data.

The design parameter data of the doctor blade may include various types of data reflecting the inherent design characteristics of the doctor blade, for example, may include but not limited to doctor blade material type data, batch data, load data, designed life data, adjustment and replacement record data etc. The embodiments of the present disclosure are not limited by the specific type and composition of the design parameter data.

In addition, the working condition data, the status monitoring data, and the design parameter data of the doctor blade may be obtained in different ways.

For the working condition data, the working condition data may be obtained from a dedicated acquisition device (e.g., a programmable controller), wherein the dedicated acquisition device acquires the working condition data according to a predetermined sampling frequency, and the computing device may obtain the working condition data from the working condition data acquired by the dedicated acquisition device. Of course, the embodiments of the present disclosure are not limited by the specific source of the working condition data and the obtaining manner thereof.

For the status monitoring data of the doctor blade, the status monitoring data of the doctor blade may be obtained from a sensor device(s) built in the doctor blade or provided outside the doctor blade, wherein the sensor device collects various types of status monitoring data to acquire the status monitoring data of the doctor blade. For example, a temperature sensor acquires temperature data at the doctor blade, a force sensor acquires contact force data on the doctor blade, and an image sensor acquires image data of the doctor blade, and so on. The computing device may obtain one or more types of data from the doctor blade status monitoring data acquired by these sensor devices. The embodiments of the present disclosure are not limited by the specific source of the status monitoring data and the obtaining manner thereof.

For the design parameter data, the computing device may search an information database for obtaining the design parameter data, or may manually collect the design parameter data according to actual requirements. The embodiments of the present disclosure are not limited by the specific source of the design parameter data and the obtaining manner thereof.

In step S220, data pre-processing is performed on the doctor blade-related data in a predetermined pre-processing manner to obtain a pre-processed data set, wherein the pre-processed data set includes the processed data respectively corresponding to the working condition data, the status monitoring data, and the design parameter data.

After the above-mentioned working condition data, status monitoring data, and design parameter data are obtained in step S210, since these pieces of data come from different sources and are obtained based on different manners, in order to ensure the data to be real-time and accurate, the pre-processing process first includes synchronizing the data obtained from different sources to obtain an original data set. For example, synchronization may be performed through a synchronization module provided in the computing device (e.g., a synchronization module in a data interface).

Specifically, for example, when the working condition data, the status monitoring data and the design parameter data are obtained through periodic sampling, due to different sampling frequencies and different starting time points of respective sampling processes, the obtained working condition data, status monitoring data and design parameter data, for example, have different starting time points on time axis, and their respective durations are different. It is also possible that partial data is missing or significantly inaccurate due to anomalies in corresponding sampling process, so that the data to be included in the obtained original data set may have incomplete data content in the spatial dimension, and the data may be discontinuous and the timings are not uniform in the temporal dimension. In this case, synchronization processing may be performed on the working condition data, the status monitoring data and the design parameter data in multiple dimensions to obtain the original data set. For example, the multiple dimensions include the spatial dimension and the temporal dimension. For example, the data may be processed in the time dimension based on the standard clock source to achieve synchronization and alignment between multi-source data. Meanwhile, various algorithms such as interpolation algorithms and conversion algorithms may be used to correct and complete data values (i.e., processing in the spatial dimension) to obtain a complete original data set for doctor blade status monitoring and evaluation.

On the basis of obtaining the working condition data, the status monitoring data and the design parameter data, synchronization processing operation is performed on the multi-source data in multiple dimensions such as the temporal dimension and the spatial dimension, so that synchronization and alignment of the multi-source data can be realized and it is beneficial to solve the problem of missing data content, thus the quality of the data in the obtained original data set is further improved, which is beneficial to subsequent processing and evaluation based on the data. At the same time, reliability and accuracy of the method for health status evaluation on the doctor blade are also improved.

Thereafter, the pre-processing process may include further processing the original data set to obtain a pre-processed data set. The pre-processing operations on the original data set may include at least one of: a data deduplication process, a data denoising process, a data encoding process, and a data filtering process. Optionally, data processing operations may also be performed firstly on the obtained working condition data, status monitoring data, and design parameter data, and then the above-mentioned synchronization processing operation for the multi-source data is performed, which is not limited in the present disclosure.

The data deduplication process is intended to remove duplicate data in a target data set (e.g., the original data set). For example, duplicate data may be retrieved and removed based on data such as timestamps, process numbers, etc.

The data denoising process is intended to remove outliers in data so as to realize data optimization. For example, distance-based detection, statistics-based detection, distribution-based outlier detection, density clustering detection, boxplot detection and other methods may be used to denoise the data, so as to remove outliers in the data.

The data encoding is intended to represent the process of processing data based on preset rules to obtain encoded data with a uniform target data format. For example, the required target data format may be determined according to analysis, modeling and evaluation, and the data is encoded accordingly based on the target data format so as to facilitate subsequent processing.

The data filtering is intended to identify and remove noise in the data and improve the contrast of valid feature information in the data. For example, weighted average filters, median filters, Gaussian filters, Wiener filters, and other methods may be used to implement the data filtering process.

As an example rather than limitation, at least one of the above pre-processing processes may be performed differently for the obtained different types of doctor blade-related data.

For example, for the case where the working condition data is Yankee cylinder rotational speed data, coating material type data, and pulp raw material type data, the dynamic boxplot may be used to filter out outlier data in the Yankee cylinder rotational speed data (data denoising), and dummy variables may be used in performing discretized encoding (data encoding) on the material type data and pulp raw material type data; for the case where the status monitoring data is the acceleration data of real-time vibration of bearings at a driving end and a non-driving end of the fixing bracket for the doctor blade, an envelope processing with a specific frequency range (determined based on experience) may be used to obtain the envelope spectrum data of the acceleration data; for the case where the design parameter data is doctor blade material type data, dummy variables may be used in performing discretized encoding, and so on. Of course, different pre-processing processes may be selected according to the required data format and quality requirements, which is not limited in the present disclosure.

It should be understood that the above only provides an exemplary pre-processing process. Other pre-processing manners may also be selected according to actual requirements.

In step S230, feature extraction is performed on the pre-processed data set in a predetermined feature extraction manner, and the extracted features are processed to obtain the processed feature data.

The feature extraction is intended to represent the process of extracting a feature description of at least a portion of the data in the pre-processed data set for the doctor blade. That is, for example, for each feature parameter, the pre-processed data set may include multiple pieces of data for the feature parameter at multiple sampling time points, then a data description feature (hereinafter, also referred to as “feature”) capable of describing the multiple pieces of data may be extracted based on the multiple pieces of data. That is, for example, for the resistance feature, the pre-processed data set may include multiple pieces of resistance value data at multiple sampling time points, and then an average value feature capable of describing the multiple pieces of resistance value data may be extracted based on the multiple pieces of resistance value data.

Optionally, the feature extraction step described in this step S230 may specifically include the following steps: for an evaluation occasion, extracting a data description feature corresponding to each feature parameter related to the working condition data in the pre-processed data set within a preset time period related to the evaluation occasion; extracting a data description feature corresponding to each feature parameter related to the status monitoring data in the pre-processed data set within the preset time period; extracting a data description feature corresponding to each feature parameter related to the design parameter data in the pre-processed data set within the preset time period; and obtaining the processed feature data through feature processing and based on the data description feature corresponding to each feature parameter respectively related to the working condition data, the status monitoring data, and the design parameter data.

Optionally, for an evaluation occasion, only data within a preset time period (also referred to as a sliding window) related to the evaluation occasion (also referred to as a sampling point) in the pre-processed data set may be selected to perform health status evaluation, thereby the evaluation result at this evaluation occasion is obtained. For example, at each evaluation occasion, the doctor blade-related data within a preset time period (e.g., 5 minutes) before the evaluation occasion may be obtained, or the doctor blade-related data within a preset time period after the evaluation occasion may also be obtained, or the doctor blade-related data within a preset time period before and after the evaluation occasion may be obtained. The time length of the preset time period may also be appropriately selected according to actual requirements, which is not limited in the present disclosure.

It should be understood that, within the preset time period, the mentioned working condition data, status monitoring data, and design parameter data each include data of at least one feature parameter (e.g., sampled at a certain frequency). For example, within the preset time period, the status monitoring data includes vibration data, contact force data, doctor blade resistance data etc. of the doctor blade.

When feature extraction is performed on the working condition data, the status monitoring data, and the design parameter data in the pre-processed data set, different feature extraction manners may be adopted according to the type and characteristics of pieces of data for respective feature parameters respectively related to the working condition data, the status monitoring data, and the design parameter data, so as to extract different types of data features. The embodiments of the present disclosure are not limited to the specific manner of feature extraction.

Based on actual requirements, performing feature extraction on the pre-processed data set may include, for example, time domain feature extraction, frequency feature extraction, time-frequency domain feature extraction, and waveform feature extraction.

The time domain feature extraction refers to extracting a time domain feature of data (e.g., the acquired signals), including but not limited to mean, variance, standard deviation, maximum, minimum, root mean square, peak-to-peak, skewness, kurtosis, waveform indicator, pulse indicator, margin indicator etc. The frequency feature extraction refers to extracting a frequency feature of data, including but not limited to mean square frequency, frequency variance, frequency band energy, etc. The time-frequency domain feature extraction refers to extracting a time-frequency domain feature of data, including but not limited to frequency band energy or time domain characteristics of the data after wavelet decomposition or empirical mode decomposition. The waveform feature extraction refers to extracting a waveform feature of the data, for example, when the data is related to the value of an acquired signal, the waveform feature includes but not limited to the feature of area enclosed by the signal waveform, the maximum/minimum derivative, the rising edge, or the falling edge, etc.

For example, in the case where feature extraction is performed on the (processed) working condition data in the pre-processed data set, when the working condition data is Yankee cylinder rotational speed data, coating material type data, and pulp raw material type data, the averaging within a sliding window may be used to obtain the Yankee cylinder rotational speed feature, and the dummy variables after data-encoding as described above are used as the feature to characterize the coating material type data and the pulp raw material type data, which are used respectively as the data description features respectively corresponding to the Yankee cylinder rotational speed, the coating material type, and the pulp raw material type (which may be used in the following text interchangeably with the Yankee cylinder rotational speed feature, the coating material type feature, and the pulp raw material type feature). The features extracted with respect to the working condition data are also referred to as working condition features.

For example, in the case where feature extraction is performed on the (processed) status monitoring data in the pre-processed data set, when the status monitoring data is acceleration data of real-time vibration of bearings at a driving end and a non-driving end of a fixing bracket for the doctor blade and temperature data, a total value of frequencies in the frequency spectrum, within a first frequency range, of the acceleration signal corresponding to the original vibration acceleration data at each evaluation occasion (sampling point) may be extracted as its acceleration feature, and a total value of frequencies in the envelope spectrum, within a second frequency range (e.g., it may be smaller than the first frequency range), of the acceleration signal at each evaluation occasion (sampling point) may be extracted as its envelope feature; and an average value of the temperature signal corresponding to temperature data within a sliding window at each evaluation occasion (sampling point) may be extracted as its temperature feature. In addition, the feature extraction is performed for both the driving end and the non-driving end, and a total of 6 features are obtained, which are used as the data description features respectively corresponding to feature parameters of the acceleration, envelope spectrum and temperature (which may be used interchangeably with the acceleration feature, the envelope feature total value feature and temperature feature respectively in the following text). Features extracted with respect to status monitoring data are also referred to as the status monitoring features.

For example, in the case where feature extraction is performed on the (processed) design parameter data in the pre-processed data set, when the design parameter data is doctor blade material type data, the dummy variables after data-encoding as described above may be directly used as the data description feature corresponding to the feature parameter of the doctor blade material type data (it may be used interchangeably with the doctor blade material type feature in the following text). The feature extracted with respect to the design parameter data is also referred to as the design parameter feature.

Optionally, the extracted data description feature corresponding to each feature parameter may also be normalized, that is, subtracting the average value of data description feature (e.g., the acceleration feature of the driving end of the fixing bracket for the doctor blade, etc.) corresponding to each feature parameter from the value of data description feature, then the result is divided by the standard deviation corresponding to the data description feature, wherein the average value and standard deviation are obtained based on historical sampling data.

In this way, with respect to different types of data, for each feature parameter, the data description feature corresponding to the feature parameter is extracted, so that the whole and comprehensive feature information can be obtained based on the local and scattered features, which is beneficial to better reflect the characteristics of all aspects of the doctor blade.

Thereafter, the data description features corresponding to all feature parameters are processed to obtain the processed feature data.

Optionally, processing the extracted features may include data fusion or data integration performed on the extracted features.

For example, in the case where the data processing is data integration, the data description features corresponding to all feature parameters may be directly combined (e.g., concatenated) to obtain the processed feature data.

As an example rather than limitation, synchronous concatenation processing may be performed on the extracted working condition feature, status monitoring feature, and design parameter feature based on the time axis to obtain a processed feature set, which is also referred to as the processed feature data.

Of course, other processing manners in the field of data processing may also be used to performing data processing on the extracted working condition feature, status monitoring feature, and design parameter feature to obtain the processed feature data. In addition, in order to more accurately characterize the doctor blade status, different weights may be assigned to each type of feature according to sensitivity for characterization of the doctor blade status. For example, the weight of status monitoring feature is higher than those of the working condition feature and the design parameter feature.

Furthermore, for at least one feature type of the working condition feature, the status monitoring feature and the design parameter feature, different weights are assigned to each data description feature under each feature type. For example, different weights are assigned to the acceleration feature, the envelope feature total value feature, and the temperature feature under the feature type of status monitoring feature.

In this way, as an example, the feature value of the data description feature corresponding to each feature parameter is multiplied by its corresponding weight as the corresponding feature value (a weighted feature value) in the processed feature set; and synchronous concatenation processing is performed for all weighted feature values, as the processed feature data.

By performing feature processing (e.g., data fusion or data integration, such as concatenation) after feature extraction, the respective extracted respective data description features can be correlated in different dimensions, so as to obtain overall and comprehensive feature information based on the local and scattered features, which is beneficial to better reflect the characteristics of various aspects of the doctor blade, thereby facilitate subsequent evaluation on the doctor blade at multiple levels, and is beneficial to improve the accuracy of evaluation.

For example, the processed feature data is a multi-dimensional feature vector F={Fᵢ|i=1, 2, . . . , k}, where k is a dimension of the multi-dimensional feature vector, and Fᵢ represents the feature value of the i-th data description feature in the processed feature data. It should be understood that the processed feature data includes feature values of the data description features corresponding to feature parameters for the working condition data, the status monitoring data, and the design parameter data, respectively. The processed feature data may include data description features with a fewer number and a higher level corresponding to feature parameters of different types (types of working condition, status monitoring, design parameter) than the data description features corresponding to original feature parameters, that is, data dimension can be reduced. In the case of simple combination (e.g., concatenation), the processed feature data may include the same number of data description features corresponding to the original feature parameters.

In step S240, evaluation is performed with respect to working condition, status monitoring, and design parameter respectively based on the processed feature data, to perform a comprehensive evaluation on the doctor blade of the papermaking machine.

In this step, first, the doctor blade is evaluated based on the working condition feature, the status monitoring feature and the design parameter feature in the processed feature data in terms of the working condition, the monitoring state and the design parameter, to obtain the first evaluation result, the second evaluation result and the third evaluation result.

Evaluating the doctor blade in terms of working condition (that is, working condition evaluation) to obtain the first evaluation result is intended to evaluate the current working condition of the doctor blade. Evaluating the doctor blade in terms of status monitoring (that is, status monitoring evaluation) to obtain the second evaluation result is intended to evaluate the performance of the doctor blade in a specific processing process. Evaluating the doctor blade in terms of design parameter (that is, design parameter evaluation) to obtain the third evaluation result is intended to evaluate the design performance of the doctor blade.

Optionally, the processed feature data may be analyzed based on a preset analysis model. For example, the preset analysis model may be trained through the working condition database, the doctor blade status monitoring database and the design parameter database included in big data. The preset analysis model that has been trained can determine, with respect to the feature value of the data description feature corresponding to each feature parameter, a corresponding performance-related indicator for the data description feature corresponding to the feature parameter.

Optionally, the performance-related indicator for each data description feature in the current processed feature data may be obtained based on a preset mapping relationship between the feature values of the data description feature corresponding to each feature parameter and performance-related indicators.

The preset mapping relationship may be stored in the form of a look-up table or a function.

For example, for each feature parameter, a preset reference threshold TS (the feature value corresponding to the doctor blade when it is completely new) and a preset scrapping threshold TE (the feature value corresponding to the doctor blade when it can no longer be used) of the data description feature of the feature parameter are given respectively, and then a deviation degree (1−|TC−TS|/|TE−TS|) of the current feature value TC of the data description feature corresponding to the feature parameter from its reference threshold is taken as a normalized performance-related indicator of the feature parameter.

That is, the preset mapping relationship may be expressed as Li=(1−|TCi−TSi|/|TEi−TSi|), where Li is the performance-related indicator of the data description feature corresponding to the i-th feature parameter in the currently obtained processed feature data, TCi is the current feature value of the data description feature corresponding to the i-th feature parameter, and TSi and TEi are the preset reference threshold and the preset scrapping threshold of the data description feature corresponding to the i-th feature parameter, respectively. Of course, the preset mapping relationship may be in other form.

As an example rather than limitation, for the working condition feature, as described in the previous example, in the case where the working condition feature includes Yankee cylinder rotational speed feature, coating material type feature, and pulp raw material type feature (data description features), the current performance-related indicators of these three data description features may be determined based on the preset mapping relationship between the feature values of these three data description features and their corresponding performance-related indicators, as the first evaluation result.

For the status monitoring feature, in the case where the status monitoring feature includes the acceleration feature, the envelope feature total value feature, and the temperature feature (for both the driving end and non-driving end), the current performance-related indicators of these six data description features may be determined based on the preset mapping relationship between the feature values of these six data description features and their corresponding performance-related indicators, as the second evaluation result.

Optionally, in the case where the status monitoring evaluation is performed, when the status monitoring feature includes the preset features, the evaluation may also be performed at multiple levels, for example, the first level of monitoring feature evaluation (e.g., evaluation is performed based on the data description feature corresponding to the feature parameter related to the status monitoring data in the processed feature data) and the second level of monitoring state evaluation (e.g., based on the evaluation result of the first level) may be included, and the second evaluation result may be obtained finally.

For example, in the case where the status monitoring feature includes the acceleration feature, the envelope feature total value feature and the temperature feature (for both the driving end and non-driving end), because these three feature parameters reflect the different aspects of the measuring points of the driving end and the non-driving end, and the sensitivity degree of the driving end and the sensitivity degree of the non-driving end to the actual status of the doctor blade are different, thus after the current performance-related indicators (which are regarded as the first-level evaluation) of these six data description features for the driving end and the non-driving end are obtained as described above, further evaluation is performed for the driving end and the non-driving end (the second-level evaluation) separately. For example, for the driving end or the non-driving end, three performance-related indicators of the acceleration feature, the envelope feature total value feature and the temperature feature corresponding thereto are weighted (the acceleration total value feature, the envelope feature total value feature and the temperature feature may be assigned with different weights) and normalized to obtain the final evaluation value of the status monitoring at the measuring point of the end, and finally two performance-related indicators for the driving end and the non-driving end are obtained as the second evaluation result.

For the design parameters, in the case where the design parameter feature includes the doctor blade material type feature, the current performance-related indicator of the doctor blade material type feature may be determined based on the preset mapping relationship between the feature values of the doctor blade material type feature and the corresponding performance-related indicators as the third evaluation result. For example, by querying the material type parameter rating score table, the normalized value of the score corresponding to the feature value of the doctor blade material type feature in the table is used as the performance-related indicator of the doctor blade material type feature, as the third evaluation result.

In addition, the working condition evaluation and the design parameter evaluation may also be similarly performed at multi-level evaluation, and the first evaluation result and the third evaluation result are generated respectively.

After obtaining the first evaluation result, the second evaluation result (the updated second evaluation result) and the third evaluation result, the comprehensive evaluation result of the health status of the doctor blade may be further obtained.

Then, an evaluation result for the health status of the doctor blade of the papermaking machine may be determined based on each performance-related indicator included in the first evaluation result, the second evaluation result and the third evaluation result.

Optionally, a health radar chart may be constructed based on each performance-related indicator obtained, that is, the health status of the doctor blade may be determined according to the area of the health radar chart.

As for an example of the health radar map, please refer to FIG. 3. FIG. 3 shows six features, which include three types of features, the working condition feature, the status monitoring feature and the design parameter feature, and the health radar map is constructed based on the performance-related indicators of these six features.

As an example rather than limitation, these six features may include the Yankee cylinder rotational speed feature, the coating material type feature, and the pulp raw material type feature (corresponding to three performance-related indicators) of working condition feature type, weighted features as obtained by weighting the acceleration feature, the envelop feature total value feature, the temperature feature of status monitoring feature type (for both the driving end and the non-driving end and corresponding to two performance-related indicators), as well as the doctor blade material type feature of design parameter type (corresponding to one performance-related indicator).

The six boundary points of the radar map are used to represent the performance-related indicators corresponding to the six features (e.g., 1 indicates the best performance and 0 indicates the lowest performance), and the area enclosed by the connecting lines of the six boundary points for example represents a health degree of the doctor blade, that is, the evaluation result of the health status of the doctor blade may be determined according to the area of the health radar map.

For example, if the area of the health radar chart exceeds a preset area threshold, it may be determined that the doctor blade is currently healthy, otherwise, it is determined that the doctor blade may be unhealthy and further operations need to be performed, such as prompting to perform a management action. The management action includes but not limited to at least one of the following items: configuring suitable working conditions, replacing doctor blade, and optimizing doctor blade characteristics (e.g., adopting the doctor blade of other models).

Optionally, the comprehensive evaluation result of the health status of the doctor blade may be represented by a value between 0 and 1, and may be determined based on the area of the health radar chart and/or the magnitude by which the area exceeding the preset area threshold.

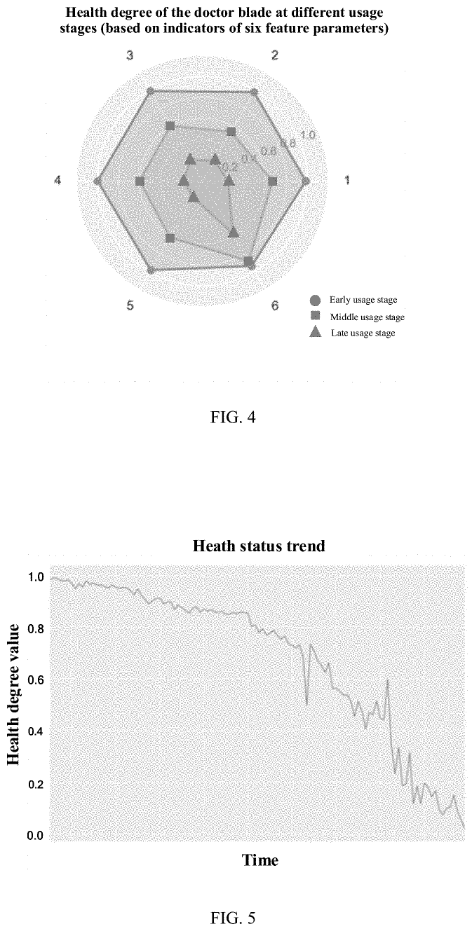

Further, FIG. 4 shows a schematic radar chart of the performance-related indicators corresponding to six feature parameters at different stages of the doctor blade's useful life.

As shown in FIG. 4, based on the same six features as those in FIG. 3, at the early usage stage of useful life, a first radar chart R1 is obtained based on the performance-related indicators of these six features; in the middle usage stage of the useful life, a second radar chart R2 is obtained based on the performance-related indicators of these six features; at the late usage stage of the useful life, a third radar chart R3 is obtained based on the performance-related indicators of these six features. The early usage stage of the doctor blade indicates that the doctor blade is in an unworn or slightly worn status, the middle usage stage indicates that the doctor blade is in a medium worn status, and the late usage stage indicates that the doctor blade is in a large area worn status.

As can be seen from FIG. 4, the earlier the usage stage, the larger the radar map area, so the area of the first radar map R1, the area of the second radar map R2 and the area of the third radar map R3 gradually decrease.

By evaluating the health status of the doctor blade under different usage conditions, it can accurately and intuitively show the overall health status change of the doctor blade in the whole usage stage, which is beneficial to the subsequent operations such as replacing the doctor blade timely based on the evaluation result, or alarming when the health degree of the doctor blade is lower than a preset value.

FIG. 5 shows a schematic diagram of the trend of the health degree values (changing over time) corresponding to the health status of the doctor blade obtained at different evaluation occasions based on the evaluation method of the embodiments of the present disclosure.

As shown in FIG. 5, the comprehensive evaluation result may be used to determine the health degree value, and the overall trend of the health degree value decreases gradually with the passage of time, indicating that the health status of the doctor blade deteriorates gradually with the passage of time (e.g., due to wear, etc.), although there are some fluctuations (e.g., due to measurement errors of various feature parameters, etc.). Thus, when the value of the comprehensive evaluation result is below the threshold, the corresponding management action can be prompted, for example, by generating an alarm.

For example, which management action is to select is determined according to the first to third evaluation results of the working condition, the doctor blade status monitoring and the doctor blade characteristics, and the management action includes but not limited to at least one of the following items: configuring the suitable working condition, replacing doctor blade, and optimizing the doctor blade design parameter (e.g., adopting the doctor blade of other models).

In addition, in other embodiments, the database used for training for example the analysis model may be expanded based on the expansion of data corresponding to the feature parameters of each type of the doctor blade and the corresponding health evaluation results, thus further realizing the self-learning and optimization of the model.

Based on the detailed description of the methods described above with reference to FIGS. 2 to 5, FIG. 6 shows a schematic diagram of a corresponding process.

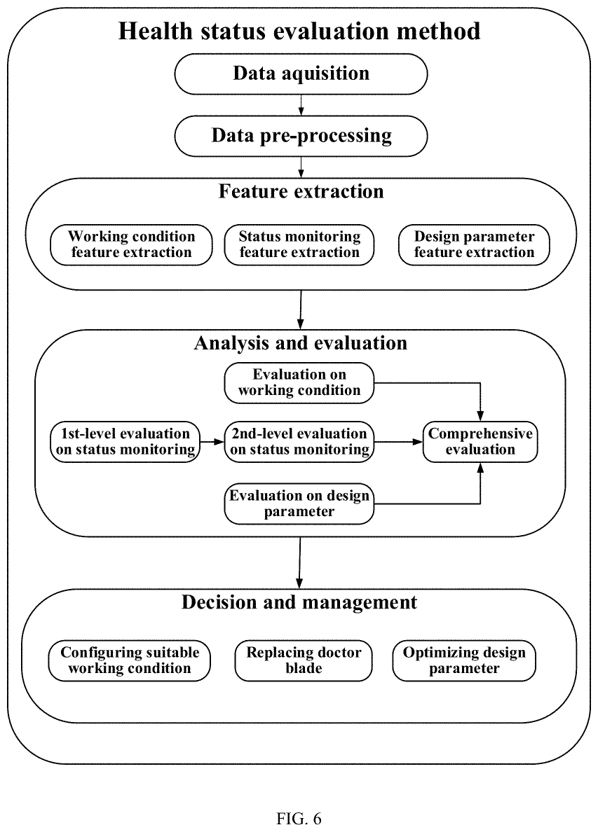

As shown in FIG. 6, first, the data acquisition process is to obtain the doctor blade-related data, wherein the doctor blade-related data includes working condition data, status monitoring data, and design parameter data of the doctor blade.

Thereafter, the pre-processing process pro-processes the doctor blade-related data to obtain a pre-processed data set. Next, the feature extraction process performs feature extraction respectively on the processed data corresponding to the working condition data, the status monitoring data, and the design parameter data, and processes the extracted features to obtain a multi-dimensional feature vector including the data description features corresponding to the feature parameters related to the above three types of data.

Thereafter, the analysis and evaluation process analyzes and evaluates the multi-dimensional feature vector, including the evaluation process of the data description features corresponding to respective feature parameters related to the working condition data, the doctor blade status monitoring data, and the design parameter data, and the comprehensive evaluation process of further evaluating the multiple evaluation results. The comprehensive evaluation process determines the comprehensive evaluation result of the health status of the doctor blade of the papermaking machine based on the first evaluation result, the second evaluation result and the third evaluation result.

Finally, the decision-making and management process determines the health status of the doctor blade based on the comprehensive evaluation result, and prompts when the health status is not good, so as to perform management actions. The management actions include but not limited to: configuring suitable working conditions, replacing doctor blade, and optimizing doctor blade characteristics (e.g., adopting the doctor blade of other models).

More details corresponding to each process in FIG. 6 have been described in detail in the above, so no repetition will be made here.

The method for evaluating the health status of the doctor blade according to the embodiments of the present disclosure can realize multi-signal, multi-working condition and multi-dimensional fusion for the original signal data can be realized, and the health status of the doctor blade can be comprehensively analyzed by combining various types of data (e.g., the working condition data, the status monitoring data, and the design parameter data), the obtained health status evaluation result of the doctor blade can more comprehensively reflect the real health status of the doctor blade and evaluate the real performance state and the change law of the doctor blade, thereby more accurate and timely warning, alarm, feedback and optimization strategies can be provided. In the field of papermaking machine where the doctor blade is applied, because the above-mentioned process may be executed at the computing device, online evaluation and monitoring can be realized, the paper-making problems caused by the doctor blade will be timely solved, finally the cost of the paper-making process is reduced, and the quality and efficiency are improved. In addition, the obtained data can be processed and modeled based on big data or machine learning, so as to evaluate and optimize the health status of the doctor blade in a digital and intelligent way.

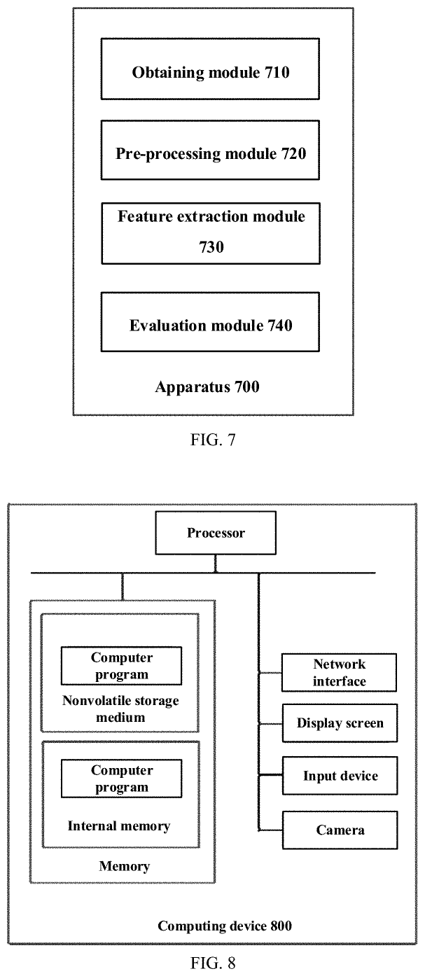

In accordance with another aspect of the present disclosure, FIG. 7 shows a structural block diagram of an apparatus for evaluating a health status of a doctor blade of a papermaking machine according to the embodiments of the present disclosure.

As shown in FIG. 7, the apparatus 700 comprises an obtaining module 710, a pre-processing module 720, a feature extraction module 730, and an evaluation module 740.

The obtaining module 710 may obtain doctor blade-related data, wherein the doctor blade-related data includes working condition data, status monitoring data, and design parameter data of the doctor blade.

Thereafter, the pre-processing module 720 may perform data pre-processing on the doctor blade-related data to obtain a pre-processed data set, wherein the pre-processed data set includes the processed data respectively corresponding to the working condition data, the status monitoring data, and the design parameter data.

Next, the feature extraction module 730 may perform feature extraction on the pre-processed data set in a predetermined feature extraction manner, and the extracted features are processed to obtain the processed feature data.

Last, the evaluation module 740 may analyze with respect to working condition, status monitoring, design parameter respectively based on the processed feature data respectively, to perform comprehensive evaluation of the health status of the doctor blade of the papermaking machine.

In addition, it should be noted that the apparatus 700 may include more or less modules according to the functions to be performed. For example, it may include a decision management module for determining a health status of the doctor blade based on the comprehensive evaluation result, and prompting when the health status is bad so as to perform management actions; and may include a self-learning module for realizing the self-learning and optimizing of the model based on the extended database. In addition, each module may be further divided into multiple sub-modules to complete the required operations.

More details of the operations of the above respective modules of the apparatus 900 have been described in detail above with reference to FIGS. 2 to 7, so no repetition will be made here.

Through the apparatus for evaluating a heath status on a doctor blade of a papermaking machine according to the embodiments of the present disclosure, multi-signal, multi-working condition and multi-dimensional fusion of the original signal data can be realized, and the health status of the doctor blade can be comprehensively analyzed by combining various types of data (e.g., the working condition data, the status monitoring data, and the design parameter data), the obtained health status evaluation result of the doctor blade can more comprehensively reflect the real status of the doctor blade and evaluate the real performance state and the change law of the doctor blade, thereby more accurate and timely warning, alarm, feedback and optimization strategies can be provided. In the field of papermaking machine where the doctor blade is applied, because the above-mentioned process may be executed at the computing device, online evaluation and monitoring can be realized, the paper-making problems caused by the doctor blade will be timely solved, finally the cost of the paper-making process is reduced, and the quality and efficiency are improved. In addition, the obtained data can be processed and modeled based on big data or machine learning, so as to evaluate and optimize the health status of the doctor blade in a digital and intelligent way.

In accordance with another aspect of the present disclosure, FIG. 8 shows a structural block diagram of a computing device 800 according to the embodiments of the present disclosure.

As shown in FIG. 8, the computing device 800 includes a processor, a memory, a network interface, an input device and a display screen that are connected by a system bus. The memory includes a nonvolatile storage medium and an internal memory. The nonvolatile storage medium of the computing device stores an operating system, and may also store a computer program, which, when executed by a processor, can cause the processor to implement various operations described in respective steps of the aforementioned method for evaluating the health status of the doctor blade. The internal memory may also store a computer program which, when executed by the processor, can cause the processor to perform various operations described in the respective steps of the same method for evaluating a health status of a doctor blade of a papermaking machine.

For example, the operations of the method for evaluating a health status of a doctor blade of a papermaking machine may include: obtaining doctor blade-related data, wherein the doctor blade-related data includes working condition data, status monitoring data, and design parameter data of the doctor blade; performing data pre-processing on the doctor blade-related data in a predetermined pre-processing manner to obtain a pre-processed data set, wherein the pre-processed data set includes processed data respectively corresponding to the working condition data, the status monitoring data, and the design parameter data; performing feature extraction on the pre-processed data set in a predetermined feature extraction manner, and processing extracted features to obtain processed feature data; and evaluating with respect to working condition, status monitoring, and design parameter respectively based on the processed feature data, to perform comprehensive evaluation on the health status of the doctor blade of the papermaking machine. More details of each step have been described in detail above, so no repetition will be made here.

The processor may be an integrated circuit chip with signal processing capability. The processor described above may be a general-purpose processor, a digital signal processor (DSP), an application specific integrated circuit (ASIC), a Field Programmable Gate Array (FPGA) or other programmable logic devices, discrete gates or transistor logic devices, and discrete hardware components. The respective methods, steps and logic diagrams disclosed in the embodiments of the present disclosure can be implemented or executed. The general-purpose processor may be a microprocessor or the processor may also be any conventional processor, etc., which may be of X84 architecture or ARM architecture.

The nonvolatile memory may be a read only memory (ROM), a programmable read only memory (PROM), an erasable programmable read only memory (EPROM), an electrically erasable programmable read only memory (EEPROM) or a flash memory. It should be noted that the memories of the methods described in the present disclosure are intended to include but not limited to these and any other suitable types of memories.

The display screen of the computing device may be a liquid crystal display screen or an electronic ink display screen, and the input device of the computing device may be a touch layer covered on the display screen, may also be a button, a trackball or a touch pad disposed on the housing, and may also be an external keyboard, a touch pad or a mouse. The computing device may be a terminal or a server.

In accordance with another aspect of the present disclosure, there is also provided a computer readable storage medium storing a computer program which, when executed by a processor, causes the processor to execute the respective steps of the method for evaluating the health status of the doctor blade of a papermaking machine as described above.

In accordance with yet another aspect of the present disclosure, there is also provided a computer program product including a computer program, which, when executed by a processor, realizes the respective steps of the method for evaluating the health status of the doctor blade of a papermaking machine as described above.

Although the present disclosure has been described in detail for various specific example embodiments thereof, each example is provided by way of explanation rather than limitation. Those skilled in the art can easily make alterations, changes and equivalents to such embodiments after understanding the above contents. Therefore, the present disclosure does not exclude such modifications, changes and/or additions to the subject matter that will be obvious to those of ordinary skill in the art. For example, features illustrated or described as part of one embodiment may be used with another embodiment to produce yet another embodiment. Therefore, it is intended that the present disclosure cover such alterations, variations and equivalents.

Unless otherwise defined, all terms (including technical and scientific terms) used herein have the same meaning as commonly understood by those of ordinary skill in the art to which the present disclosure belongs. It will be further understood that terms, such as those defined in commonly used dictionaries, should be interpreted as having the meaning that is consistent with their meaning in the context of the relevant art and will not be interpreted in an idealized or overly formal sense unless expressly so defined herein.

The above is illustration of the present disclosure and should not be construed as making limitation thereto. Although some exemplary embodiments of the present disclosure have been described, those skilled in the art can easily understand that many modifications may be made to these exemplary embodiments without departing from the creative teaching and advantages of the present disclosure. Therefore, all such modifications are intended to be included within the scope of the present disclosure as defined by the appended claims. As will be appreciated, the above is to explain the present disclosure, it should not be constructed as limited to the specific embodiments disclosed, and modifications to the embodiments of the present disclosure and other embodiments are intended to be included in the scope of the attached claims. The present disclosure is defined by the claims and their equivalents.

What is claimed is:

1. A method for evaluating a health status of a doctor blade of a papermaking machine, comprising:
obtaining doctor blade-related data, wherein the doctor blade-related data includes working condition data, status monitoring data, and design parameter data of the doctor blade;
performing data pre-processing on the doctor blade-related data in a predetermined pre-processing manner to obtain a pre-processed data set, wherein the pre-processed data set includes processed data respectively corresponding to the working condition data, the status monitoring data, and the design parameter data;
performing feature extraction on the pre-processed data set in a predetermined feature extraction manner, and processing extracted features to obtain processed feature data; and
evaluating with respect to working condition, status monitoring, and design parameter respectively based on the processed feature data, to perform a comprehensive evaluation on the health status of the doctor blade of the papermaking machine.

2. The method according to claim 1, wherein the working condition data includes Yankee cylinder rotational speed data, coating material type data, and pulp raw material type data; the status monitoring data includes acceleration data of real-time vibration of bearings at a driving end and a non-driving end of a fixing bracket for the doctor blade and temperature data; and the design parameter data includes doctor blade material type data,
wherein performing data pre-processing on the doctor blade-related data in a predetermined pre-processing manner to obtain a pre-processed data set comprises:
performing at least one of the following respective pre-processing processes based on different types of data of the doctor blade-related data: a data deduplication process, a data denoising process, a data encoding process, and a data filtering process.

3. The method according to claim 1, wherein performing feature extraction on the pre-processed data set in a predetermined feature extraction manner and processing extracted features to obtain processed feature data comprises: for a current evaluation occasion,
extracting a data description feature corresponding to each feature parameter related to the working condition data in the pre-processed data set within a preset time period related to the evaluation occasion, as a working condition feature;
extracting a data description feature corresponding to each feature parameter related to the status monitoring data in the pre-processed data set within the preset time period, as a status monitoring feature;
extracting a data description feature corresponding to each feature parameter related to the design parameter data in the pre-processed data set within the preset time period, as a design parameter feature; and
obtaining the processed feature data through feature processing and based on the data description features corresponding to each feature parameter related to the working condition data, the status monitoring data, and the design parameter data.

4. The method according to claim 3, further comprising:
assigning different weights to the working condition feature, the status monitoring feature and the design parameter feature according to sensitivity to characterization for the health status of the doctor blade, and assigning, for at least one feature type of the working condition feature, the status monitoring feature and the design parameter feature, different weights to each data description feature under each feature type,
wherein obtaining the processed feature data through feature processing and based on the data description features corresponding to each feature parameter related to the working condition data, the status monitoring data, and the design parameter data comprises:
multiplying a feature value of the data description feature corresponding to each feature parameter with a corresponding weight to obtain a weighted feature value of the data description feature of the feature parameter; and
performing synchronous concatenation processing for each weighted feature value, to obtain the processed feature data.

5. The method according to claim 1, wherein evaluating with respect to working condition, status monitoring, and design parameter respectively based on the processed feature data, to perform a comprehensive evaluation on the health status of the doctor blade of the papermaking machine comprises:
analyzing the processed feature data to obtain a first evaluation result for the working condition of the doctor blade, a second evaluation result for the status monitoring and a third evaluation result for the design parameter respectively, wherein the first evaluation result, the second evaluation result and the third evaluation result each includes a performance-related indicator of each working condition feature in the processed feature data, a performance-related indicator of each status monitoring feature in the processed feature data and a performance-related indicator of each design parameter feature in the processed feature data;
determining a comprehensive evaluation result for the health status of the doctor blade of the papermaking machine based on each performance-related indictor included in the first evaluation result, the second evaluation result, and the third evaluation result.

6. The method according to claim 5, wherein determining a comprehensive evaluation result for the health status of the doctor blade of the papermaking machine based on each performance-related indictor included in the first evaluation result, the second evaluation result, and the third evaluation result comprises:
when the status monitoring feature includes a preset feature, performing a second-level evaluation on the second evaluation result to obtain an updated second evaluation result, wherein the updated second evaluation result includes an updated performance-related indicator;
determining the comprehensive evaluation result for the health status of the doctor blade of the papermaking machine based on each performance-related indicator included in the first evaluation result, the updated second evaluation result and the third evaluation result.

7. The method according to claim 5, wherein each performance-related indicator is obtained based on a preset mapping relationship between feature values of the data description feature corresponding to each feature parameter and performance-related indicators.

8. The method according to claim 6, further comprising:
prompting to perform a management action based on the comprehensive evaluation result of evaluating the health status of the doctor blade of the papermaking machine.

9. A computing device, comprising:
a processor;
a memory having stored thereon a computer program which, when executed, causes the processor to implement respective steps of the method for evaluating a health status of a doctor blade according to claim 1.

10. A non-transient computer-readable storage medium having computer-readable instructions stored thereon, wherein when the instructions are executed by a computer, the method of claim 1 is performed.

11. An apparatus for evaluating a health status of a doctor blade of a papermaking machine, comprising:
an obtaining module configured to obtain doctor blade-related data, wherein the doctor blade-related data includes working condition data, status monitoring data, and design parameter data of the doctor blade;
a pre-processing module configured to perform data pre-processing on the doctor blade-related data in a predetermined pre-processing manner to obtain a pre-processed data set, wherein the pre-processed data set includes processed data respectively corresponding to the working condition data, the status monitoring data, and the design parameter data;
a feature extraction module configured to perform feature extraction on the pre-processed data set in a predetermined feature extraction manner, and to process extracted features to obtain processed feature data; and
an evaluation module configured to evaluate with respect to working condition, status monitoring, and design parameter respectively based on the processed feature data, to perform a comprehensive evaluation on the health status of the doctor blade of the papermaking machine.
